(19) United States
(12) Patent Application Publication
(10) Pub. No.: US 2025/0088581 A1
(43) Pub. Date: Mar. 13, 2025

(54) ACCESSORY DEVICES WITH TEXTILE-BASED WALLS

(71) Applicant: Apple Inc., Cupertino, CA (US)

(72) Inventors: Kristen L. CRETELLA, San Francisco, CA (US); Chengrui ZHANG, San Jose, CA (US); Joshua A. HOOVER, Boulder, CO (US); Mengshen WU, Wuhan (CN); Timothy C. WULFF, Boulder, CO (US); Yue LIANG, Shenzhen (CN); Stephanie A. WHALEN, San Francisco, CA (US); Camille I. HENROT, San Francisco, CA (US); Deepak SHARMA, Sunnyvale, CA (US); Stephen T. SCHOOLEY, Menlo Park, CA (US); Joshua SIU, Fremont, CA (US); Donald L. OLMSTEAD, Aptos, CA (US); Catherine A. DECLARO, Santa Cruz, CA (US); Hao DONG, Sunnyvale, CA (US); Amy ZHOU, Palo Alto, CA (US); Anne-Marie HECK, San Francisco, CA (US); Jonathan Gomez GARCIA, San Francisco, CA (US); Daniel J. HAGEWOOD, Boulder, CO (US); Jessica J. LU, Menlo Park, CA (US)

(21) Appl. No.: 18/749,472

(22) Filed: Jun. 20, 2024

Related U.S. Application Data
(60) Provisional application No. 63/537,803, filed on Sep. 11, 2023.

(51) Int. Cl. H04M 1/724

(52) U.S. Cl. CPC H04M 1/724

(57) ABSTRACT

An accessory device includes multiple walls and textile layers covers the walls. The textile layers may be of the same materials. However, one of the textile layers may include a film that provides protections against stains and fraying. The textile layers may come together at a seam. Accessory devices may include a shell that includes a pocket used to seat the textile layers in order to form the seam. An additional seam may be formed by two ends of a textile layer. The additional seam may be supported by a reinforcement layer, and may also align with an opening formed in the accessory device.

### CROSS REFERENCE TO RELATED APPLICATION(S)

This application claims the benefit of U.S. Provisional Application No. 63/537,803, entitled “ACCESSORY DEVICES WITH TEXTILE-BASED WALLS,” filed Sep. 11, 2023, the entirety of which is incorporated herein by reference.

### TECHNICAL FIELD

This application is directed to accessory devices, and more particularly, to accessory devices with multiple textile layers having various modifications and enhancements for added durability.

### BACKGROUND

Accessory devices provide a protective cover for electronic devices such as smartphones. There are several different types of exterior materials used with accessory devices, which may enhance the appearance of the electronic device. However, some materials are susceptible to staining from exposure to liquids. Also, some materials are susceptible to fraying over time.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an example of an accessory device, in accordance with aspects of the present disclosure.

FIG. 2 illustrates an alternate perspective view of an accessory device, showing a seam formed between textile layers of the accessory device, in accordance with aspects of the present disclosure.

FIG. 3 illustrates a cross sectional view of an accessory device, showing internal features of the accessory device, in accordance with aspects of the present disclosure.

FIG. 4 illustrates a partial cross sectional view of an accessory device, showing various aspects of the film on the wall, in accordance with aspects of the present disclosure.

FIG. 5 illustrates an exploded view showing exemplary layers of a wall of an accessory device, in accordance with aspects of the present disclosure.

FIG. 6 illustrates a plan view that shows a rear portion of an accessory device, in

accordance with aspects of the present disclosure.

FIG. 7 illustrates a cross sectional view of the accessory device shown in FIG. 6, taken along line 7-7, showing features of a trim of the accessory device, in accordance with aspects of the present disclosure.

FIG. 8 illustrates a perspective view of a textile layer with a seam and a reinforcement layer that covers the seam, in accordance with aspects of the present disclosure.

FIG. 9 illustrates a perspective view of an accessory device with a textile layer that includes a seam supported by a reinforcement layer, in accordance with aspects of the present disclosure.

FIG. 10 illustrates a cross sectional view of the accessory device shown in FIG. 6, taken along line 10-10, showing a process for forming the indicium in the accessory device, in accordance with aspects of the present disclosure.

FIG. 11 illustrates a perspective view of an alternate example of an accessory device, showing multiple textile layers of the accessory device, in accordance with aspects of the present disclosure.

FIG. 12 illustrates an exploded view of a wall of an accessory device, showing a textile layer modified to receive a magnet, in accordance with aspects of the present disclosure.

FIG. 13, FIG. 14, FIG. 15, and FIG. 16 illustrate partial cross sectional views of an accessory device, as well as a magnet and a circuit stored in the accessory device, in accordance with aspects of the present disclosure.

FIG. 17 illustrates a cross sectional view of a wall of an accessory device with a compressible layer embedded in the wall, in accordance with aspects of the present disclosure.

FIG. 18 illustrates a perspective view of an example of an accessory device with various components coupled together by magnets, in accordance with aspects of the present disclosure.

FIG. 19 illustrates a cross sectional view of a wall of an accessory device, showing a button capable of magnetically coupling with the wall by magnets, in accordance with aspects of the present disclosure.

FIG. 20 illustrates a perspective view of an example of an accessory device, showing magnets integrated with the accessory device, in accordance with aspects of the present disclosure.

FIG. 21 illustrates a perspective view of an example of an accessory device, showing an indicium capable of being in installed in the accessory device, in accordance with aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject technology is directed to accessory devices for electronic devices including mobile wireless communication devices (e.g., smartphones, tablet computing devices). In particular, the subject technology is directed to modifying textile layers of accessory devices to increase durability and limit or prevent stains and/or fraying to the textile layers. In one or more implementations, a film is applied to a sidewall of the accessory device. The film may include thermoplastic polyurethane (TPU), a polymer film, acrylic, or a combination thereof, as non-limiting examples. Moreover, both the sidewall and a back wall of the accessory device may include one or more textile layers. However, the film may be applied only to the sidewall in some instances. Additionally, the respective ends of the textile layers on the sidewall and the back wall may form a seam. Further, the accessory device may include a shell to provide rigidity to the sidewall and portions of the back wall. The shell may include a pocket, or cavity, that provides a space in which the respective textile layers may be folded and positioned, and may promote formation of the seam. Beneficially, the pocket allows the textile layers to align with each other and provide a generally flush and continuous exterior. In one or more implementations, a portion of the film is removed on the sidewall to reduce noise that otherwise occurs due to friction between the electronic device and the sidewall when an electronic device is removed from the accessory device.

Additionally, the textile layer on the sidewall may also form an additional seam at respective ends. The seam may be reinforced by a polymer-based material. Further, the textile layer may be cut along a particular direction (e.g., warp) of the textile to reduce the appearance of the seam. Also, the seam may be aligned with an opening of the accessory device to further obscure the appearance of the seam.

In one or more implementations, the shell of the accessory device may terminate in the back wall. In this regard, the back wall may include several additional materials to form a stack that provides structural support while also concealing features such as a magnet (representative of an assembly of magnets) and circuitry. For example, the back wall may include several polymer-based and foam-based layers. Additionally, a fabric layer (e.g., felt) may include openings for the magnet and the circuitry. The aforementioned layers may covered by textile layers, which form the exterior of the wall.

In one or more implementations, the accessory device includes an opening formed in the back wall and a trim that surrounds the opening. The trim may be wrapped with a textile layer that is separate from a textile layer on the back wall. The respective textile layers may also be folded to form a seam to provide an appearance of continuity between the textile layers.

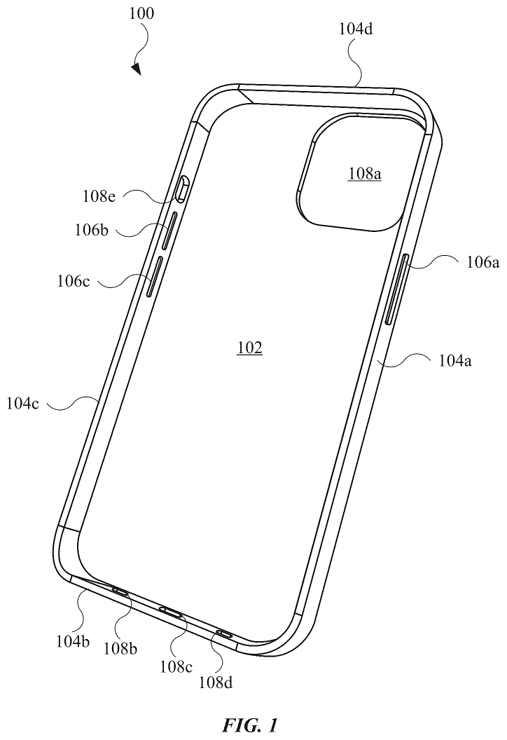

These and other embodiments are discussed below with reference to FIGS. 1-21. However, those skilled in the art will readily appreciate that the detailed description given herein with respect to these Figures is for explanatory purposes only and should not be construed as limiting.

FIG. 1 illustrates a perspective view of an accessory device 100, in accordance with aspects of the present disclosure. Accessory device 100 may take the form of a case or protective cover for mobile wireless communication devices, including electronic devices such as smartphones and tablet computing devices, as non-limiting examples. As shown, accessory device 100 includes a wall 102. Wall 102 may be referred to as a bottom wall or back wall. Accessory device 100 may further include several walls extending from wall 102. For example, accessory device 100 may include a wall 104a, a wall 104b, a wall 104c, and a wall 104d. Each of walls 104a, 104b, 104c, and 104d may be referred to as a sidewall. Collectively, wall 102 and walls 104a, 104b, 104c, and 104d combine to form an internal volume, or space, to receive a mobile wireless communication device. Also, in one or more implementations, wall 102 and walls 104a, 104b, 104c, and 104d may include a textile layer formed from woven fabric, knitted fabric, non-woven fabric, polyurethane, elastomer, or a combination thereof, as non-limiting examples.

Accessory device 100 may include several features designed to accommodate one or more features of a mobile wireless communication device. For example, accessory device 100 may include a button 106a, a button 106b, and a button 106c, each of which being designed to be actuated/depressed and move relative to a wall on which each of buttons 106a, 106b, and 106c are located. A “button” shown and/or described herein may include a push button, touch sensor, or the like capable of operating (e.g., actuating) a switch, trigger, or other similar function of an electronic device. For example, button 106a, located on wall 104a, is designed to move relative to wall 104a. Also, when a mobile wireless communication device is positioned in accessory device 100, each of buttons 106a, 106b, and 106c may align with a respective button of the mobile wireless communication device. In this regard, actuation of button 106a (representative of buttons 106b and 106c) may result in actuation of an electronic device button aligned with button 106a. While button 106a is positioned on wall 104a and buttons 106b and 106c are positioned on wall 104c, buttons 106a, 106b, and 106c may be positioned on other walls. Generally, the number and location of the buttons of accessory device 100 may correspond to the number and location, respectively, of buttons on a mobile wireless communication device.

Accessory device 100 may include several additional features designed to accommodate a mobile wireless communication device. For example, accessory device 100 may include several openings to enable unimpeded access to ambient environment for input/output functionality for such features as images sensors (e.g., camera), camera flash, or the like, as well as unimpeded access to sensors of the electronic devices including but not limited to sound, light, temperature, pressure, etc., input/output ports for wired or direct contact communication of data and/or power such as through a connector or surface contact. Additionally, openings of accessory device 100 may enable access to any other portion or part of the electronic device enhanced by undamped, unmuffled, or otherwise un-occluded access to ambient conditions for optimal performance. As shown, accessory device 100 may include an opening 108a formed in wall 102. Opening 108a may accommodate one or more cameras, a camera flash, and/or a microphone of a mobile wireless communication device. Accessory device 100 may further include an opening 108b, an opening 108c, and an opening 108d formed in wall 104b. Each of openings 108b, 108c, and 108d may align with a feature of a mobile wireless communication device, such as one or more audio transducers (e.g., speaker, microphone) and/or a port used for charging a battery of the mobile wireless communication device and/or data communication to/from the mobile wireless communication device. Accessory device 100 may further include an opening 108e formed in wall 104c. Opening 108e may accommodate a switch (e.g., slider switch) of a mobile wireless communication device. While openings 108a, 108b, 108c, 108d, and 108e are shown in discrete locations, openings 108a, 108b, 108c, 108d, and 108e may be generally located anywhere on accessory device 100 to accommodate a feature of a mobile wireless communication device.

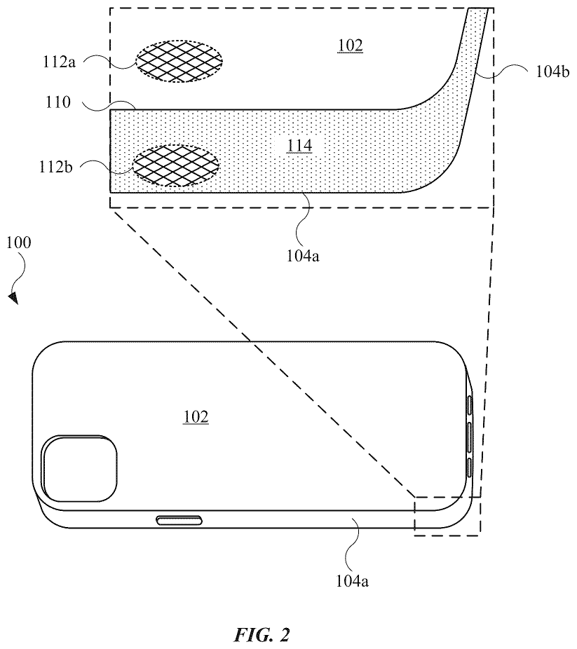

FIG. 2 illustrates an alternate perspective view of accessory device 100, showing a seam 110 formed between textile layers of accessory device 100, in accordance with aspects of the present disclosure. As shown, wall 102 includes a textile layer 112a and wall 104a includes a textile layer 112b. Although textile layers 112a and 112b are partially shown in FIG. 2, textile layers 112a and 112b may cover a respective surface of wall 102 and 104a in their entirety. Further, textile layer 112b may cover wall 104b, as well as walls 104c and 104d (shown in FIG. 1). Further, respectively ends of textile layers 112a and 112b may approximately terminate to form seam 110.

In one or more implementations, textile layers 112a and 112b may include the same material. Accordingly, each of textile layers 112a and 112b may include woven fabric, knitted fabric, non-woven fabric, polyurethane, elastomer, or a combination thereof, as non-limiting examples, and wall 102 and wall 104a may include the same textile-based material. However, a film may cover at least one of wall 102 and wall 104a. For example, wall 104a may include a film 114 disposed on textile layer 112b. Film 114 may include one or more polymer-based materials, and will be shown in further detail below. Based on film 114 on walls 104a and 104b (as well as walls 104c and 104d shown in FIG. 1) but not on wall 102, the appearance (e.g., color, texture) of walls 104a, 104b, 104c, and 104d may be different than that of wall 102.

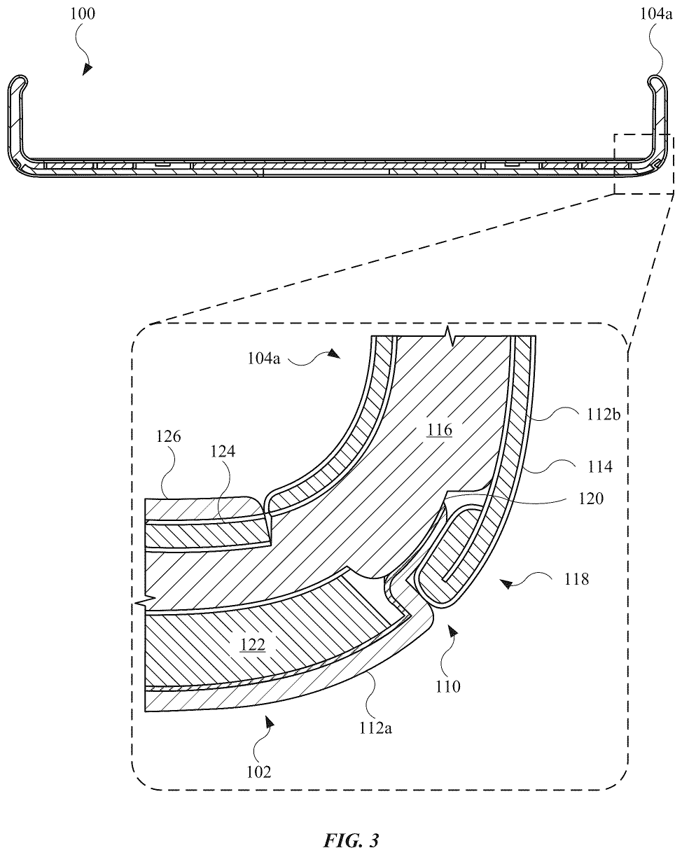

FIG. 3 illustrates a cross sectional view of accessory device 100, showing internal features of accessory device 100, in accordance with aspects of the present disclosure. Accessory device 100 may include a shell 116. In one or more implementations, shell 116 includes one or more polymer-based materials, such as polyester, a copolymer, or a combination thereof. Additionally, shell 116 may form the general shape and structural backbone of wall 104a (as well as of walls 104b, 104c, and 104d, shown in FIG. 1). Further, shell 116 may at least partially extend into wall 102. As shown in FIG. 3, textile layer 112b may wrap around multiple surfaces of shell 116. Based on film 114 covering textile layer 112b, film 114 may also wrap around multiple surfaces of shell 116.

Shell 116 may include a pocket 118. For example, shell 116 may include an indentation 120, representing an indented surface of shell 116, that forms pocket 118. Pocket 118 may provide a volume or space in which textile layers 112a and 112b terminate and form seam 110. Seam 110 is generally located at a radius, or curved location, of accessory device 100. As shown, textile layer 112a covers indentation 120, and textile layer 112b, including film 114, is folded and overlaps (e.g., positioned on) textile layer 112a. In order to alter the thickness of textile layer 112a at a location corresponding to pocket 118, textile layer 112a may undergo a deboss operation to flatten a portion of textile layer 112a. Beneficially, based on pocket 118, textile layers 112a and 112b may be flush, or substantially flush, with respect to each other at seam 110, thus providing a generally smooth continuous surface from textile layer 112a to textile layer 112b (including film 114), or vice versa.

Pocket 118 of shell 116 may further include a size and shape to accommodate other materials of accessory device 100. For example, wall 102 may include a foam layer 122 that is positioned, or at least partially positioned, in pocket 118. Further, shell 116 may be modified to accommodate other materials. For example, wall 102 may further include a film 124 and a textile layer 126 that covers film 124. Film 124 may include a polyethylene terephthalate (PET) film, as a non-limiting example. The textile layer 126 may include a liner textile or liner fabric, as a non-limiting example. Although not expressly labeled, several of the aforementioned layers be coupled or secured with shell 116 or other layers by an adhesive, as a non-limiting example.

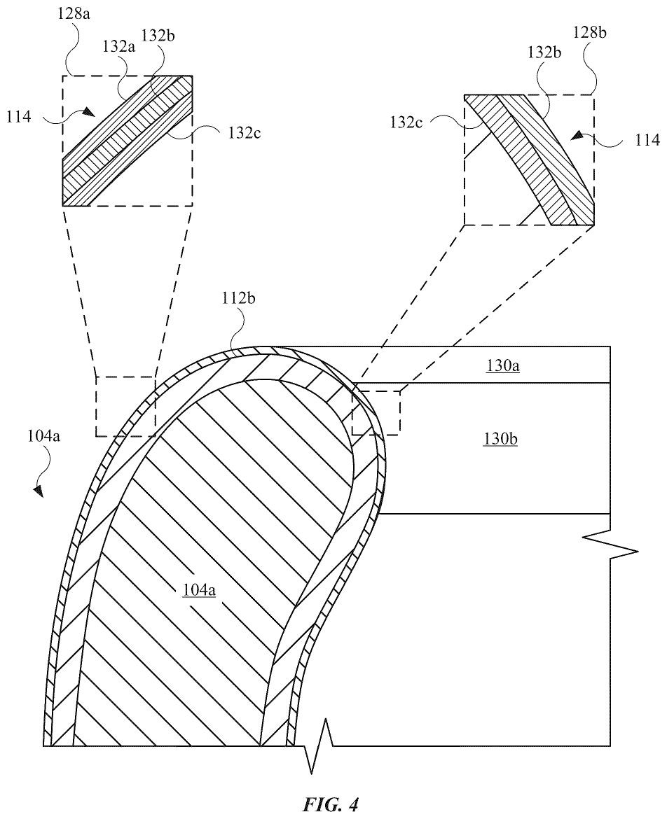

FIG. 4 illustrates a partial cross sectional view of accessory device 100, showing various aspects of film 114 on wall 104a, in accordance with aspects of the present disclosure. The composition of film 114 may differ at a section 130a and at a section 130b of wall 104a, which is representative of differing compositions of film 114 on walls 104b, 104c, and 104d shown in FIG. 1. For example, as shown in an enlarged view 128a, film 114 may include a layer 132a, a layer 132b, and a layer 132c at section 130a. In one or more implementations, layer 132a includes an acrylic layer. In this regard, layer 132a may be used to prevent wall 104a, and in particular, textile layer 112b, from staining. Alternatively, layer 132b may include a polymer film. In one or more implementations, layer 132b includes TPU. In this regard, layer 132b may be used to prevent textile layer 112b from fraying. In one or more implementations, layer 132c includes an adhesive that is at least partially embedded in textile layer 112b to secure film 114 with textile layer 112b.

As shown in an enlarged view 128b, film 114 may include layers 132b and 132c at section 130b. In this regard, layer 132a may be removed from film 114 at section 130b. Exemplary removal operations may include laser ablation. Layer 132a may be removed from film 114 at a location, or approximate location, of wall 104a that may contact an electronic device (not shown in FIG. 4) while inserting the electronic device into and/or extracting the electronic device from accessory device 100. In this regard, the frictional forces between the electronic device and wall 104a may be reduced, thus facilitating inserting and/or extracting the electronic device and reducing noise associated with inserting and/or extracting the electronic device.

Additionally, other materials may be added to film 114. For example, in one or more implementations, film 114 includes pigments to alter the appearance (e.g., color) of accessory device 100.

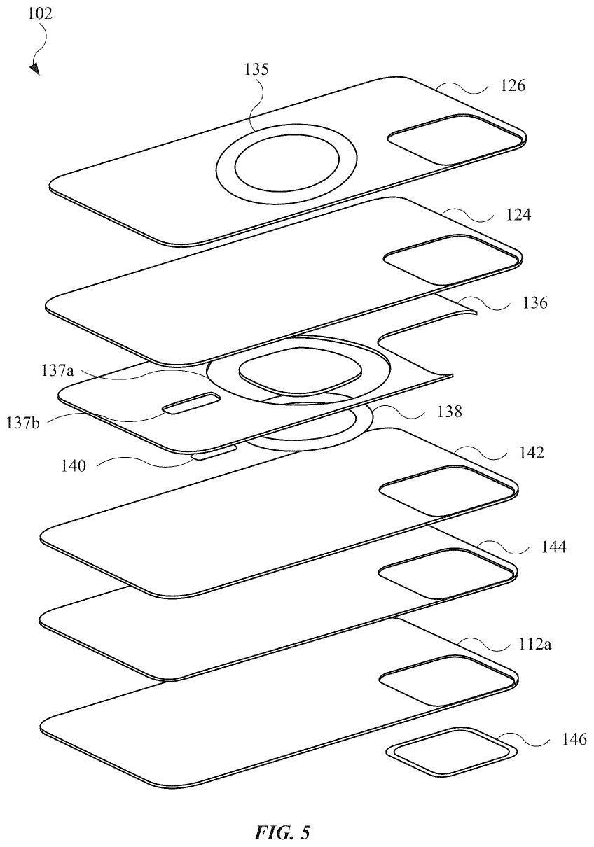

FIG. 5 illustrates an exploded view showing exemplary layers of wall 102 of accessory device 100 (shown in FIG. 1), in accordance with aspects of the present disclosure. Wall 102 may include a textile layer 126 (also shown in FIG. 3). In one or more implementations, textile layer 126 include any material described herein for a textile layer or textile-based layer. When a magnet 138 (representing one or more magnetic elements) is integrated into wall 102, textile layer 126 include a deboss region 135 that provides an indented shape that corresponds to the shape of magnet 138. As shown, magnet 138 includes a ring shape and accordingly, deboss region 135 also includes a ring shape.

Wall 102 may further include film 124 (also shown in FIG. 3). In one or more implementations, film 124 includes a PET film. Film 124 may be referred to as a capping layer. Film 124 may provide wall with flatness or planarity, and may further hide the presence of magnet 138 in wall 102. Wall 102 may further include a layer 136. In one or more implementations, layer 136 includes a felt layer. In this regard, layer 136 may provide wall 102 with flexibility. Also, layer 136 may include an opening 137a and an opening 137b to provide a space for magnet 138 and a circuit 140. Magnet 138 may be used to magnetically couple an accessory (e.g., wireless charging module) to accessory device 100. Accordingly, magnet 138 may facilitate charging an electronic device. In one or more implementations, circuit 140 is a communication circuit, such as a near-field communication (NFC) circuit, as a non-limiting example. Accordingly, an accessory device (e.g., accessory device shown in FIG. 1) that integrates features of wall 102 may communicate with other devices, such as an electronic device positioned in the accessory device.

Wall 102 may further include a layer 142. In one or more implementations, layer 142 includes a PET film. Layer 142 may be referred to as a capping layer. Layer 142 may provide stiffness and prevent warping of wall 102, and further hide the presence of magnet 138 in wall 102. Wall 102 may further include a layer 144. Layer 144 may include a foam layer, and may include open cell foam, as a non-limiting example. Layer 144 may provide wall 102 with compressibility, thus improving the feel of an accessory device that includes wall 102. Wall 102 may further textile layer 112a (also shown in FIG. 3) that provides an outer cosmetic layer for wall 102.

The various layers may include a respective opening such that, when the layers are combined, the openings align to form an opening (e.g., opening 108a shown in FIG. 1). Further, a trim 146 may be attached to the opening of wall 102. This will be shown below.

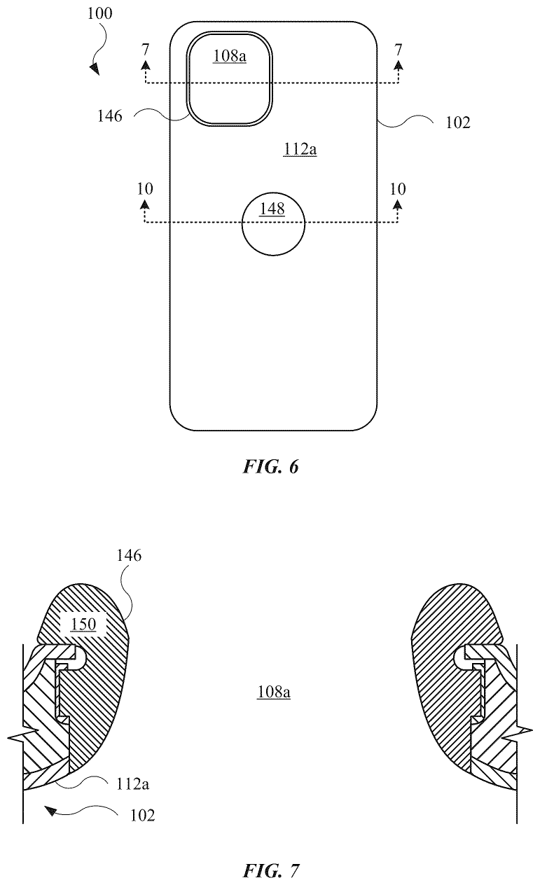

FIG. 6 illustrates a plan view that shows a rear portion of accessory device 100, in accordance with aspects of the present disclosure. As shown, trim 146 surrounds opening 108a at a perimeter of opening 108a. Wall 102 may further include an indicium 148. As a non-limiting example, indicium 148 may represent a logo associated with a manufacturer of accessory device 100. In one or more implementations, indicium 148 is a separate material from textile layer 112a. In one or more implementations, indicium 148 is formed by an operation (e.g., deboss operation) to textile layer 112a.

FIG. 7 illustrates a cross sectional view of the accessory device shown in FIG. 6, taken along line 7-7, showing features of trim 146, in accordance with aspects of the present disclosure. Trim 146 may be coupled (e.g., adhered) with wall 102, at opening 108a, by an adhesive (shown, not labeled). Trim 146 may include a material 150, such as a polycarbonate material, as a non-limiting example. Additionally, trim 146 may include a textile layer that wraps or covers material 150. The textile layer may be separate from textile layer 112a of wall 102, and may also align with textile layer 112a to provide a continuous surface.

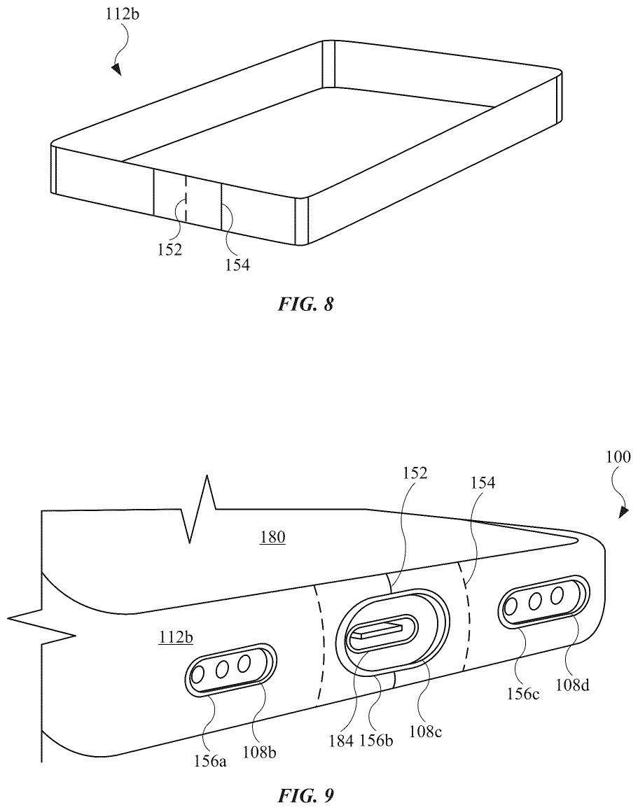

FIG. 8 illustrates a perspective view of textile layer 112b with a seam 152 and a reinforcement layer 154 that covers seam 152, in accordance with aspects of the present disclosure. Seam 152, or joint, may represent a connection between two ends of textile layer 112b. Seam 152 may include a woven material to further hide the ends of textile layer 112b. Further, seam 152 may extend along a warp (e.g., lengthwise direction) of textile layer 112b, thus reducing the appearance of seam 152. Reinforcement layer 154 may include woven material, such as a monofilament woven material. In one or more implementations, reinforcement layer 154 includes a polyetheretherketone (PEEK) material.

FIG. 9 illustrates a perspective view of accessory device 100 with textile layer 112b that includes seam 152 supported by reinforcement layer 154, in accordance with aspects of the present disclosure. When textile layer 112b is integrated with accessory device 100, textile layer 112b may be inverted relative to what is shown in FIG. 8. In this regard, reinforcement layer 154 (shown as dotted lines) may be covered by textile layer 112b. In other words, reinforcement layer 154 is generally not visible when integrated with accessory device 100.

As shown, an electronic device 180 is positioned in accessory device 100. Openings 108b, 108c, and 108d may align with features of accessory device 100. For example, electronic device 180 includes openings (shown, not labeled) for audio transducers (e.g., speakers, microphones) of electronic device 180. Openings 108b and 108d are aligned with the openings of electronic device 180. Electronic device 180 may further include a port 184, and opening 108c (representing the largest area of an opening among openings 108b, 108c, and 108d) may align with port 184. Further, seam 152 of textile layer 112b may align with opening 108c. As a result, seam 152 may be less visible to users as seam 152 is separated by opening 108c. In order to further focus user attention away from seam 152, each of openings 108b, 108c, and 108d may be surrounded by a coating 156a, a coating 156b, and a coating 156c, respectively. In one or more implementations, each of coatings 156a, 156b, and 156c includes paint.

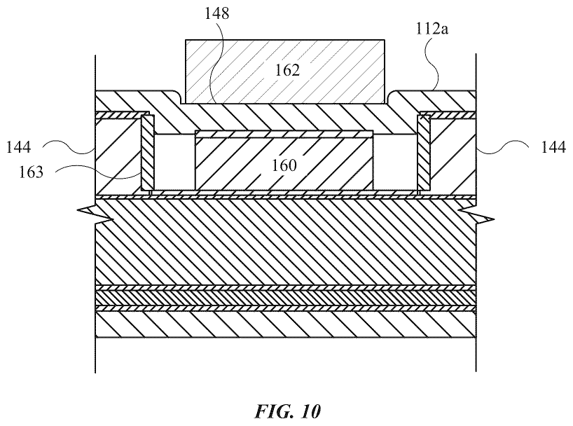

FIG. 10 illustrates a cross sectional view of accessory device 100 shown in FIG. 6, taken along line 10-10, showing a process for forming indicium 148 in accessory device 100, in accordance with aspects of the present disclosure. Layer 144 (e.g., foam layer) may include an opening or void to receive a spacer 160. In one or more implementations, spacer 160 includes TPU. The material makeup, including hardness, of spacer 160 may absorb the force applied by a tool 162 (e.g., horn) to form indicium 148. Put another way, spacer 160 may be more robust in comparison to layer 144. In this regard, spacer 160 may promote distinct edges of indicium 148. Optionally, layer 144 may include an adhesive ring 163 to provide additional stiffness.

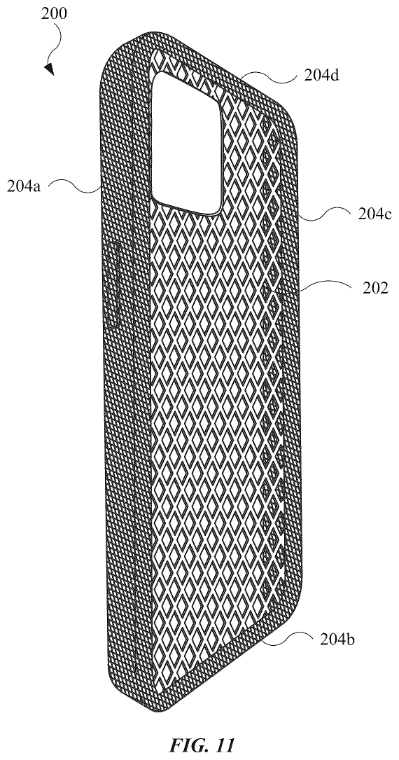

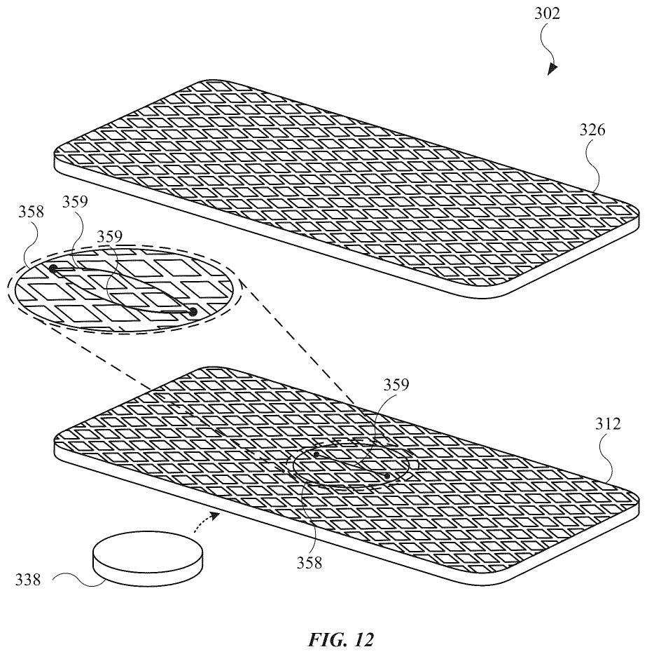

FIGS. 11-21 show and describe alternate examples of accessory devices. The accessory devices shown and described in FIGS. 11-21 may include at least some structures and/or materials, as well as associated functions and features, shown and/or described for herein accessory device 100. Further, accessory device 100 may be modified to include at least some structures and/or materials, as well as associated functions and features, shown and/or described herein accessory devices in FIGS. 11-12.

FIG. 11 illustrates a perspective view of an alternate example of an accessory device 200, showing multiple textile layers of accessory device 200, in accordance with aspects of the present disclosure. As shown, accessory device 200 includes a wall 202 (e.g., a back wall) and a wall 204a, a wall 204b, a wall 204c, and a wall 204d (e.g., sidewalls), each of which extend from wall 202. Further, wall 202 may include a textile layer of one material, and walls 204a, 204b, 204c, and 204d may include a textile layer of another, different material. As shown, the respective pitches of the textile layers may differ. Further, the textile layer forming wall 202 may represent the only layer of wall 202. In this regard, wall 202 may take the form of a semi-transparent wall in which an electronic device (not shown in FIG. 11) may be visible when viewing wall 202. Also, the thickness of wall 202 may not inhibit a magnetic field from an electronic device or a wireless charging module (not shown in FIG. 11) from passing through wall 202.

FIG. 12 illustrates an exploded view of a wall 302 of an accessory device, showing a textile layer modified to receive a magnet, in accordance with aspects of the present disclosure. As shown, wall 302 may include a textile layer 326 and a textile layer 312. When wall 302 is assembled, textile layer 326 may cover textile layer 312. Further, at least one of the textile layers 326 and 312 may be modified to receive a magnet 338. For example, textile layer 312 may include a pocket 358 with an opening 359. As shown in the enlarged view, opening 359 of textile layer 312 may take the form of a slit into which magnet 338 may be inserted into pocket 358.

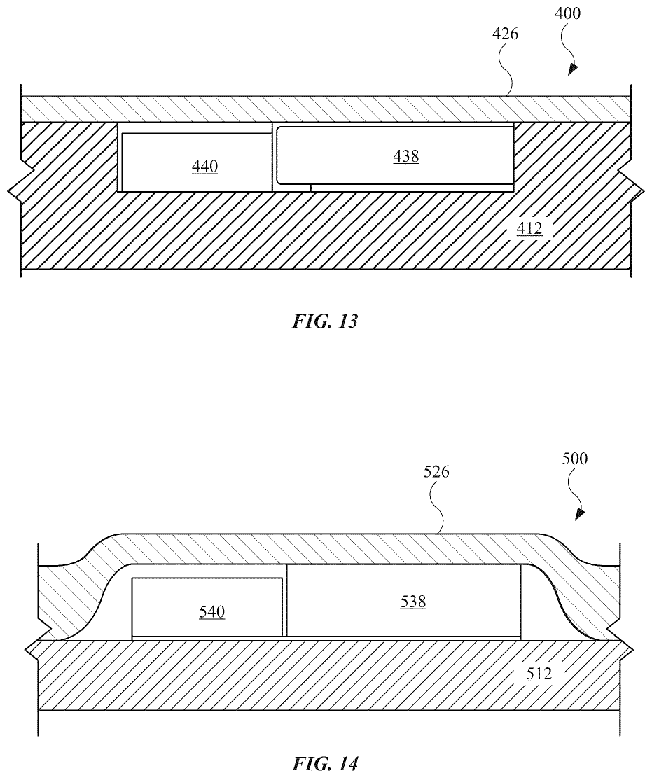

FIG. 13, FIG. 14, FIG. 15, and FIG. 16 illustrate partial cross sectional views of an accessory device, as well as a magnet and a circuit stored in the accessory device, in accordance with aspects of the present disclosure.

FIG. 13 illustrates a partial cross sectional view of an accessory device 400 that includes a textile layer 412 and a textile layer 426. As shown, textile layer 412 may include a thickness such that, when an indentation or partial opening is formed in textile layer 412, a space is provided by textile layer 412 to accommodate a magnet 438 and a circuit 440 of accessory device 400. When textile layer 426 covers textile layer 412, magnet 438 and circuit 440 are also covered. Moreover, the location, or position, of magnet 438 and circuit 440 are hidden based on the space provided by textile layer 412 and with minimal, if any contact, between textile layer 426 and magnet 438 and circuit 440.

FIG. 14 illustrates a partial cross sectional view of an accessory device 500 that includes a textile layer 512 and a textile layer 526. As shown, textile layer 512 may provide a surface on which a magnet 538 and a circuit 540 (of accessory device 500) are positioned. When textile layer 526 covers textile layer 512, magnet 538 and circuit 540 are also covered. However, the location of magnet 538 and circuit 540 may be visible as textile layer 526 contacts both magnet 538 and circuit 540. The bulging or protruding of textile layer 526 may provide to a user of accessory device 500 an indication as to the location of magnet 538 and/or circuit 540.

FIG. 15 illustrates a partial cross sectional view of an accessory device 600 that includes a textile layer 612 and a textile layer 626. As shown, textile layer 612 may provide a surface on which a magnet 638 and a circuit 640 (of accessory device 600) are positioned. Further, accessory device 600 may include a textile layer 627. Textile layer 627 may cover textile layer 612, and in particular, may cover magnet 638 and circuit 640. Further, textile layer 627 may be integrated with accessory device 600 by covering ends of textile layer 627 with textile layer 626. Further, the location of magnet 638 and circuit 640 may be visible as textile layer 627 contacts both magnet 638 and circuit 640. The bulging or protruding of textile layer 627 may provide to a user of accessory device 600 an indication as to the location of magnet 638 and/or circuit 640.

FIG. 16 illustrates a partial cross sectional view of an accessory device 700 that includes a textile layer 712 and a textile layer 726. As shown, textile layer 726 may wrap around both a magnet 738 and a circuit 740 of accessory device 700. Further, textile layer 712 may include a thickness such that, when an indentation or partial opening is formed in textile layer 712, a space is provided by textile layer 712 to accommodate textile layer 726, magnet 738, and circuit 740. Further, a split or discontinuity between textile layers 712 and 726 may provide to a user of accessory device 700 an indication as to the location of magnet 738 and/or circuit 740.

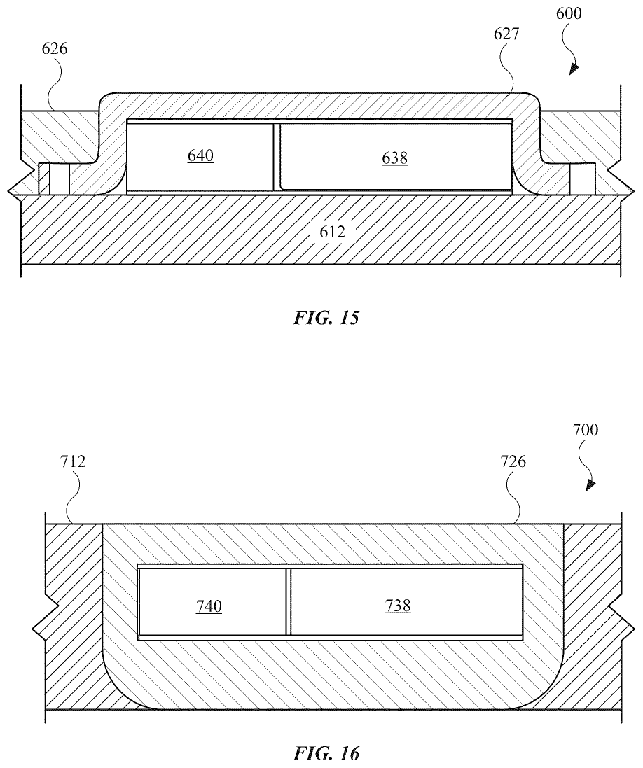

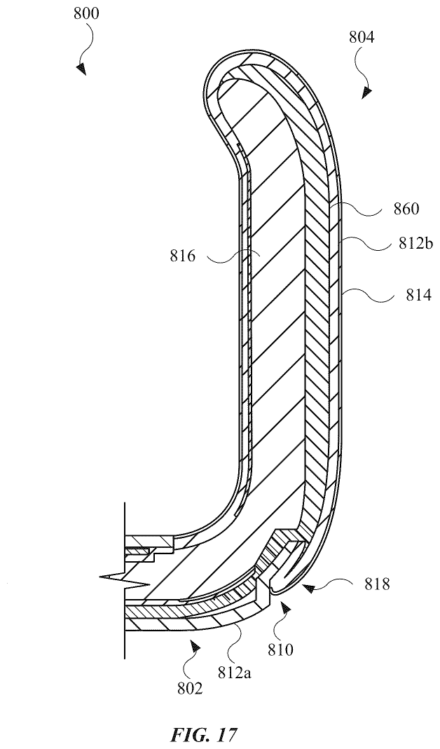

FIG. 17 illustrates a cross sectional view of a wall 804 of an accessory device 800 with a compressible layer 860 embedded in wall 804, in accordance with aspects of the present disclosure. Wall 804 (representative of additional walls) may take the form a side wall of accessory device 800 that extends from a wall 802 of accessory device 800. As shown, wall 802 may include a textile layer 812a. Further, wall 804 may include a shell 816. Also, a textile layer 812b and a film 814 may wrap around shell 816. Textile layer 812b and film 814 may also cover compressible layer 860. In one or more implementations, compressible layer 860 includes a foam material or foam layer. By incorporating compressible layer 860 into wall 804, wall 804 may be compressible, or at least partially compressible, thus giving a user of accessory device 800 a different feel (e.g., plushness). Further, compressible layer 860 may extend to a pocket 818 of shell 816, with pocket 818 defining a location, or approximate location, of a seam 810 formed between textile layers 812a and 812b. Also, while compressible layer 860 is shown as being covered by one or more layers that form wall 804, compressible layer 860 may be in different locations in or on wall 804, and may be visible (e.g., uncovered by textile layer 812b and film 814) in one or more implementations.

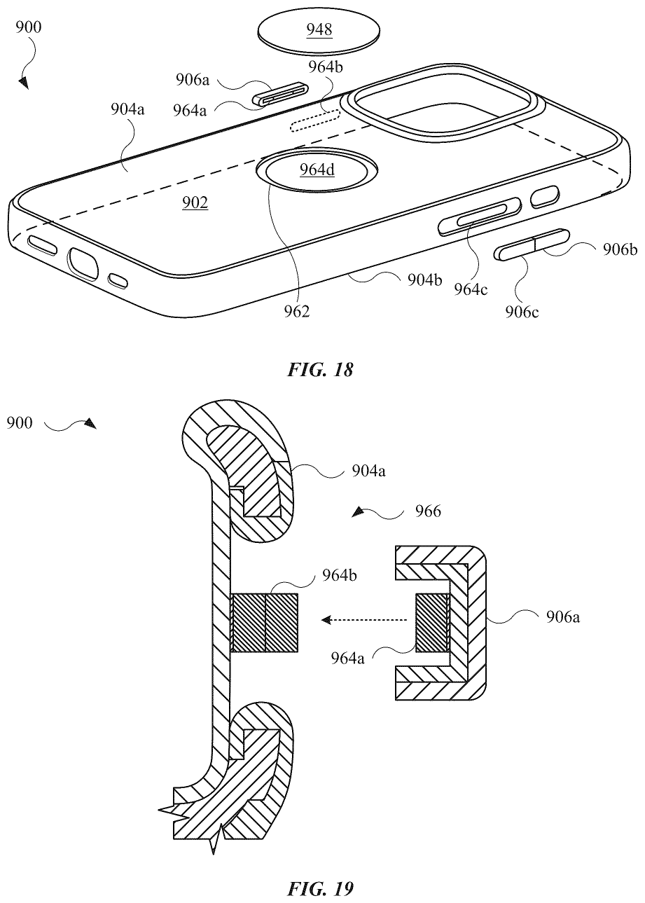

FIG. 18 illustrates a perspective view of an example of an accessory device 900 with various components coupled together by magnets, in accordance with aspects of the present disclosure. As shown, accessory device 900 includes a wall 902. Accessory device 900 may further include a wall 904a (shown as dotted lines) and a 904b, each of which is extending from wall 902. Accessory device 900 may further include a button 906a capable of coupling to wall 904a, as well as a button 906b and a button 906c capable of coupling to wall 904b. Moreover, using one or more magnets (e.g., magnetic elements and/or magnetically attractable elements), button 906a may magnetically couple to wall 904a, and buttons 906b and 906c may magnetically couple to wall 904b. For example, wall 904a may include a magnet 964a and button 906a may include a magnet 964b designed to magnetically couple with magnet 964a. Additionally, wall 904b may include a magnet 964c and buttons 906b and 906c may each include a magnet (not shown in FIG. 18) designed to magnetically couple with magnet 964c.

Further, accessory device 900 may include an indicium 948. Indicium 948 may be coupled to wall 902 at an opening 962 of wall 902. Opening 962 may represent a partial opening of wall 902 in which one or more layers of wall 902 include an opening, but additional layers do not include an opening. Wall 902 may further include a magnet 964d and indicium 948 may include a magnet (not shown in FIG. 18) designed to magnetically couple with magnet 964d.

Based on the use of magnets, accessory device 900 may take the form of a modular accessory device in which at least some components (e.g., button 906a) may magnetically couple to accessory device 900 and may be decoupled form accessory device 900. As a result of the modular design, accessory device 900 may allow for replaceable components to, for example, replace a broken component or change the component to change the appearance (e.g., color, texture) and/or functionality.

FIG. 19 illustrates a cross sectional view of wall 904a of accessory device 900, showing button 906a capable of magnetically coupling with wall 904a by magnets 964a and 964b, in accordance with aspects of the present disclosure. As shown, wall 904a includes an opening 966 designed to receive button 906a. Further, magnet 964a may be concealed, or at least partially concealed, within button 906a. When magnets 964a and 964b are magnetically coupled together, button 906a is magnetically coupled with wall 904a.

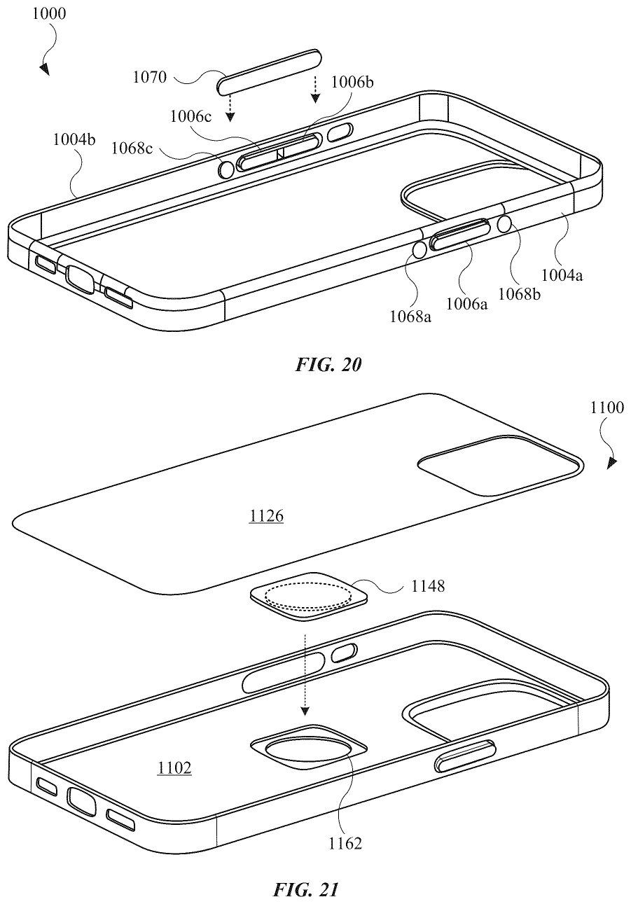

FIG. 20 illustrates a perspective view of an example of an accessory device 1000, showing magnets integrated with accessory device 100, in accordance with aspects of the present disclosure. As shown, accessory device 1000 includes a wall 1004a and a wall 1004b. Accessory device 1000 may further include a button 1006a coupled to wall 1004a, as well as a button 1006b and a button 1006c coupled to wall 1004b.

Accessory device 1000 may further include several magnets. For example, accessory device 1000 may include a magnet 1068a and a magnet 1068b located in wall 1004a. Further, accessory device 1000 may include a magnet 1068c located in wall 1004b. Magnets 1068a, 1068b, and 1068c may provide a variety of functions. For example, one or more of magnets 1068a, 1068b, and 1068c may allow for an additional component(s) to magnetically couple with accessory device 1000, such as a cover (not shown in FIG. 20). As another example, one or more of magnets 1068a, 1068b, and 1068c may be detected, or detectable, by an electronic device (not shown in FIG. 20) to identify accessory device 1000. Also, one or more of magnets 1068a, 1068b, and 1068c may be partially covered by a label. For example, accessory device 1000 may include a label 1070 that covers, or at least partially covers, magnets 1068b and 1068c.

FIG. 21 illustrates a perspective view of an example of an accessory device 1100, showing an indicium 1148 capable of being in installed in accessory device 1100, in accordance with aspects of the present disclosure. As shown, accessory device 1100 includes an opening 1162. Opening 1162 may pass completely through wall 1102. Further, however, opening 1162 may take the form of a stepped opening. Further, indicium 1148 may include a platform such that indicium 1148 takes the form of a stepped indicium. Indicium 1148 may couple to opening 1162 based on the respective stepped features. When indicium 1148 is positioned in opening 1162, indicium 1148 may be visible through wall (e.g., at an alternate orientation of accessory device 1100). Further, a rear side of indicium 1148 may be covered by a textile layer 1126, as well as one or more additional layers (not shown in FIG. 21).

Various examples of aspects of the disclosure are described below as clauses for convenience. These are provided as examples, and do not limit the subject technology.

Clause A: An accessory device may include a first wall that includes a first textile layer. The accessory device may further include a second wall extending from the first wall. The second wall may include a second textile layer that forms a seam with the first textile layer. The second wall may further include a film that covers the second textile layer.

Clause B: An accessory device may include a first wall. The accessory device may further include a second wall extending from the first wall. The second wall may include a shell that includes a pocket. The accessory device may further include a first textile layer that covers the first wall. The accessory device may further include a magnet disposed in the first wall. The accessory device may further include a second textile layer that covers the second wall. The first textile layer and the second textile layer may be positioned in the pocket.

Clause C: An accessory device may include a first wall that includes a first textile layer. The accessory device may further include a second wall extending from the first wall. The second wall may include a second textile layer that forms a seam with the first textile layer. The second wall may include an opening, and the second textile layer may include a first end and a second end connected to the first end by a joint. he joint may be separated by the opening.

One or more of the above clauses can include one or more of the features described below. It is noted that any of the following clauses may be combined in any combination with each other, and placed into a respective independent clause, e.g., clause A, B, or C.

Clause 1: the first textile layer may formed from a material. The second textile layer may be formed from the material.

Clause 2: further including a shell positioned in the first wall and the second wall. The shell may include a pocket. The first textile layer may be positioned in the pocket. The second textile layer may be positioned in the pocket.

Clause 3: wherein the second textile layer overlaps the first textile layer.

Clause 4: wherein the film includes: a first material; and a second material that covers the first material.

Clause 5: wherein: the first material includes a thermoplastic polyurethane, and the second material includes an acrylic or a polymer film.

Clause 6: wherein at least a portion of the first material is uncovered by the second material.

Clause 7: further including a trim. The first wall may include an opening, and the trim may be adhered to the first wall around the opening.

Clause 8: further including a button coupled to the second wall.

Clause 9: wherein the shell at least partially extends into the first wall.

Clause 10: wherein: the first wall includes a compressible layer that includes an opening, and the magnet is positioned in the opening.

Clause 11: wherein the second textile layer overlaps the first textile layer.

Clause 12: further including a film positioned on the second textile layer.

Clause 13: wherein the film includes a thermoplastic and an acrylic that covers the thermoplastic.

Clause 14: wherein: the first textile layer is formed from a material, and the second textile layer is formed from the material.

Clause 15: wherein the second textile layer may include a film.

Clause 16: wherein: at a first location, the film includes a thermoplastic and an acrylic that covers the thermoplastic, and at a second location different from the first location, the thermoplastic is uncovered by the acrylic.

Clause 17: further including: a magnet positioned in the first wall, and a button coupled to the second wall.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An accessory device, comprising:
a first wall comprising a first textile layer; and
a second wall extending from the first wall, the second wall comprising:
a second textile layer that forms a seam with the first textile layer; and
a film that covers the second textile layer.

2. The accessory device of claim 1, wherein:
the first textile layer is formed from a material, and
the second textile layer is formed from the material.

3. The accessory device of claim 1, further comprising a shell positioned in the first wall and the second wall, wherein:
the shell comprises a pocket,
the first textile layer is positioned in the pocket, and
the second textile layer is positioned in the pocket.

4. The accessory device of claim 3, wherein the second textile layer overlaps the first textile layer.

5. The accessory device of claim 1, wherein the film comprises:
a first material; and
a second material that covers the first material.

6. The accessory device of claim 5, wherein:
the first material comprises a thermoplastic polyurethane, and
the second material comprises an acrylic or a polymer film.

7. The accessory device of claim 5, wherein at least a portion of the first material is uncovered by the second material.

8. The accessory device of claim 1, further comprising a trim, wherein:
the first wall comprises an opening, and
the trim is adhered to the first wall around the opening.

9. An accessory device, comprising:
a first wall;
a second wall extending from the first wall, the second wall comprising a shell that includes a pocket;
a first textile layer that covers the first wall;
a magnet disposed in the first wall; and
a second textile layer that covers the second wall, wherein the first textile layer and the second textile layer are positioned in the pocket.

10. The accessory device of claim 9, further comprising a button coupled to the second wall.

11. The accessory device of claim 9, wherein the shell extends into the first wall.

12. The accessory device of claim 9, wherein:
the first wall comprises a compressible layer that includes an opening, and
the magnet is positioned in the opening.

13. The accessory device of claim 9, wherein the second textile layer overlaps the first textile layer.

14. The accessory device of claim 9, further comprising a film positioned on the second textile layer.

15. The accessory device of claim 14, wherein the film comprises a thermoplastic and an acrylic that covers the thermoplastic.

16. The accessory device of claim 9, wherein:
the first textile layer is formed from a material, and
the second textile layer is formed from the material.

17. An accessory device, comprising:
a first wall comprising a first textile layer; and
a second wall extending from the first wall, the second wall comprising a second textile layer that forms a seam with the first textile layer, wherein:
the second wall comprises an opening, and
the second textile layer comprises a first end and a second end connected to the first end by a joint, wherein the joint is separated by the opening.

18. The accessory device of claim 17, wherein the second textile layer comprises a film.

19. The accessory device of claim 18, wherein:
at a first location, the film comprises a thermoplastic and an acrylic that covers the thermoplastic, and
at a second location different from the first location, the thermoplastic is uncovered by the acrylic.

20. The accessory device of claim 17, further comprising:
a magnet positioned in the first wall, and
a button coupled to the second wall.
